(19) United States
(12) Patent Application Publication
(10) Pub. No.: US 2022/0058616 A1
(43) Pub. Date: Feb. 24, 2022

(54) METHOD FOR VOICE TAGGING AN ELECTRONIC RECEIPT ACQUIRED AFTER A TRANSACTION

(71) Applicant: Peter Garrett, San Francisco, CA (US)

(72) Inventor: Peter Garrett, San Francisco, CA (US)

(21) Appl. No.: 17/013,591

(22) Filed: Sep. 5, 2020

Related U.S. Application Data
(63) Continuation-in-part of application No. 16/997,746, filed on Aug. 19, 2020.

(51) Int. Cl. G06Q 20/32; G06Q 20/36

(52) U.S. Cl. CPC G06Q 20/3272; G06Q 20/36; G06Q 20/3278

(57) ABSTRACT

A method for characterization of an electronic receipt acquired through a receipt capture process to a host computing device is provided, the capture process using image capture, scan capture, or electronic capture features leveraged through SW extension of a wallet or money pay application running on a host computing device functioning as a transaction device or as a host device to a transaction device, the receipt accounting for a transaction from a point of sale (POS) terminal or network node.

### CROSS-REFERENCE TO RELATED DOCUMENTS

The present invention claims priority to a U.S. patent non-provisional patent application Ser. No. 16/997,746, filed on Aug. 19, 2020 entitled “METHOD FOR VOICE TAGGING AN ELECTRONIC RECEIPT ACQUIRED AFTER A TRANSACTION” the disclosure of which is included herein at least by reference.

### BACKGROUND OF THE INVENTION

### 1. Field of the Invention

The present invention is in the field of financial transacting including over a network and pertains particularly to methods and apparatus for appending data to receipts electronically or optically captured during or just after a transaction occurs.

### 2. Discussion of the State of the Art

Payment cards are part of a payment system used by financial institutions like banks, for example, to enable cardholders to access funds held in designated bank accounts or credit accounts. The cardholder may make payments by electronic funds transfer (EFT) and access automated teller machines (ATM's). There are several types of payment cards in the art, perhaps the most common classes being credit cards and debit cards.

A more recent type of payment card existing in the art is generally termed a smart card in the art. Smart cards are payment cards that contain a unique card number and some security information such as an expiration date or card verification value (CVV) and a magnetic strip and an embedded euro-pay master card and visa (EMV) chip (secure element) enabling various machines (transaction point terminals) like point of sale (POS) machines to read and access information from the card.

More recently, smart cards have been adapted as mobile dynamic smart transaction cards. A dynamic smart card may have multiple payment card data dynamically loaded onto the single form factor of the card. A user may add any or all payment card data from debit, credit, and loyalty accounts to a mobile application associated with the smart card, such as into a cloud wallet application. The user may load the data onto the smart card via Bluetooth wireless technology or any other wireless to technology.

All-in-one smart cards are referred to in the field as dynamic smart cards. An owner of a dynamic smart card may load multiple payment account data sets onto a single payment card form factor. A user may add payment card data sets for debit, credit, gift, and loyalty to the dynamic smart card. For example, the user may leverage a mobile phone application (executed on phone) such as a mobile wallet application associated with the dynamic smart card to authenticate (identity, confirm) and move the payment card data sets onto the dynamic smart card over a Bluetooth™ or other wireless network connection between the user's smart phone and the dynamic smart card before the card is used in a transaction.

One important aspect of an expenditure is whether or not the expenditure or part of the expenditure may be a tax deduction. In general practice some applications like bank card applications tied to banks may enable a user working in the application to browse expenditure items by category and item specifics for the purpose of assigning items as tax-deductible expenditures made by the user. However, the user must navigate much data to find entries for marking as tax deductible entries. Moreover, such institutions are not required or set up to record any additional information other than the expense and the payee. With more complex payment services including dynamic smart cards to which any wallet cloud stored card may be represented it may be desired that potential tax-deductible expenditures might be marked and categorized in real time just before a card purchase is made.

One problem that arises is managing the location of receipts that back up and validate claimed expenditures used to reduce tax burden. Hard receipts are still quite common in our digital experience and are often misplaced or lost, become ink faded and illegible, and accidentally thrown away.

The inventor is aware of a system that enables a user to capture receipts form a POS terminal or from Email or messaging accounts during or just after a transaction is made by the user resulting in the receipt being captured onto the mobile phone or other mobile device hosting a transaction made from a transaction card or wireless transaction device and then uploaded to the mobile phone.

In the system known to the inventor, the user run a wallet application or other money pay application on the mobile telephone that includes extensions connected to other useful applications available on the mobile phone such as a camera feature for taking a picture of a hard printed receipt, scanning a receipt using an optical character recognition feature, or retrieving a receipt after it is sent electronically to a user address on the network for email or from text services.

Typically a wireless signal, push notification, or wireless command is communicated to the user mobile phone wallet application as a transaction device is read wherein the signal, notification, or command is received by the running wallet application typically connected to a cloud server where stored receipts may be kept in an organized fashion for later access by the user or an agent working on behalf of the user with authorization from the user. One feature of the system is that however the receipt is captured, it immediately displays in an application screen in the wallet or money pay application and controls may appear on screen that may allow the user to save or not save the receipt, assign a general business category to the receipt, including flagging the receipt for tax deduction purposes and filing the receipt for upload to the cloud server hosting the wallet account or money pay application.

It may be desired by a user to be able to more specifically characterize the receipt including input describing specific circumstances in the environment of the transaction, which otherwise may be forgotten if not actively recorded. Such information may help the user recall what led to the receipt more than a transaction receipt would reveal.

Therefore, what is clearly needed is a method and apparatus for electronically characterizing captured receipts through a wallet or money pay application feature that may trigger just after a transaction the characterizations attached as data to aggregated receipts before archiving the aggregated receipts for later retrieval.

### BRIEF SUMMARY OF THE INVENTION

According to an embodiment of the present invention, a method for characterization of an electronic receipt acquired through a receipt capture process to a host computing device is provided, the capture process using image capture, scan capture, or electronic capture features leveraged through SW extension of a wallet or money pay application running on the host computing device, the receipt accounting for a transaction from a point of sale (POS) terminal or network node including the steps (a) capturing the receipt for display in application screen on the host computing device using one of one or more application features available on the computing device, (b) resulting from a prompt in the application screen, determining to characterize the receipt captured using one of an audio recording feature or a voice-to text-feature resident on the host computing device, (c) inputting voice through a microphone on the computing device to create an audio recording or a voice-to-text input to the application containing the characterization of the captured receipt, and (d) saving the characterization text or media and receipt in association to file on the host computing device using a save function in the application screen displaying the captured receipt.

In one embodiment, in (a) the receipt is for a transaction conducted with a transaction device wherein the transaction device is a dynamic transaction card having a writable memory, a micro controller unit (MCU), and a wireless chip for wireless communications. In one embodiment, in (a) the host computing device is a wireless mobile phone adapted to communicate with the POS terminal via wireless chip to function as the transaction device.

In one embodiment, in (b) the application is a wallet application or a payment application running on the host computing device in communication with a transaction device. In one embodiment, in (c) the one or more application features executed are executed by the application at the discretion of the user working in the application.

### BRIEF DESCRIPTION OF THE DRAWINGS

FIG. 1 is an architectural view of a communications network that supports real-time electronic receipt capture and aggregation according to an embodiment of the present invention.

FIG. 2 is an elevation view of the mobile telephone of FIG. 1. executing the mobile payment application of FIG. 1.

FIG. 3 is a block diagram depicting the point of sale architecture of FIG. 1 and a capture event of a printed receipt according to an embodiment of the present invention.

FIG. 4 is an architectural diagram of an Email loop supporting electronic receipt capture according to another embodiment.

FIG. 5 is a process flow chart depicting steps for capturing and storing a receipt electronically according to one embodiment of the invention.

FIG. 6 is a process flow chart depicting steps for capturing and storing a receipt electronically according to another embodiment of the invention.

FIG. 7 is a sequence diagram depicting a semi-automated interaction sequence supporting voice characterization tagging of a captured receipt according to an embodiment of the present invention.

### DETAILED DESCRIPTION OF THE INVENTION

In various embodiments described in enabling detail herein, the inventor provides a unique apparatus and methods for capturing receipts electronically and aggregating captured receipts for data storage. The present invention is described using the following examples, which may describe more than one relevant embodiment falling within the scope of the invention.

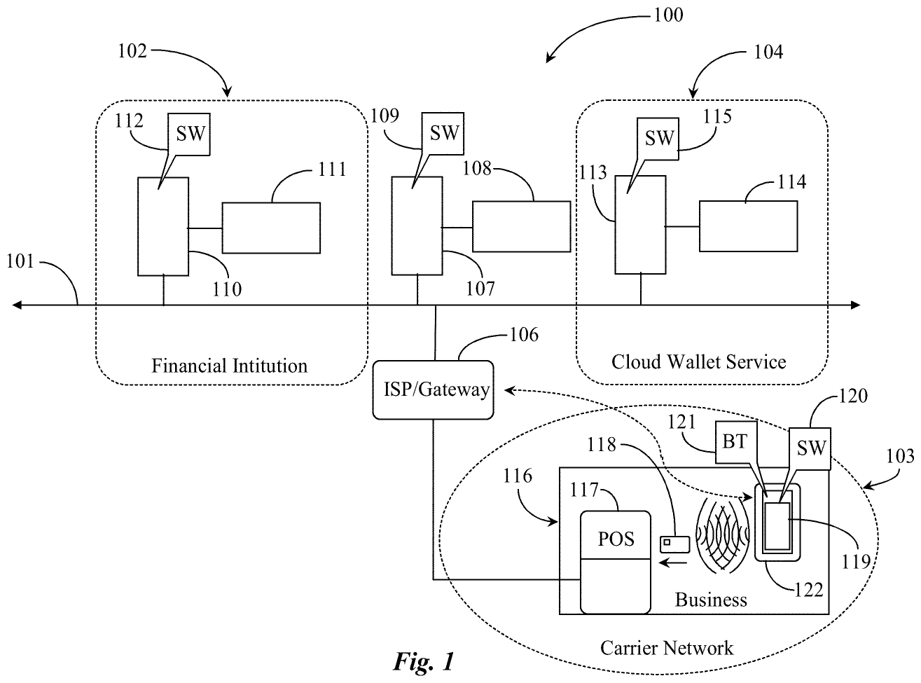

FIG. 1 is an architectural view of a communications network 100 that supports real-time electronic receipt capture and aggregation according to an embodiment of the present invention. Communications network 100 includes network backbone 101. Network backbone 101 may represent all lines, equipment, and access points routers and gateways that make up the network as a whole including connected sub networks. Communications network 100 may be an Internet network or another wide-area-network (WAN) without departing from the spirit and scope of the present invention. There are no geographic limits to the practice of the invention.

Backbone 101 supports a network cloud labeled cloud wallet service 104. Cloud wallet service 104 may be adapted by a financial mobile cloud wallet service company to store credit card data, debit card data, and other electronic card or account data, for a mobile user, represented herein as user phone 122 having a dynamic transaction card 118 that may be programmed with a selected set of card transaction data, for example, to make a specific transaction. Cloud wallet service 104 includes a server 113 supported by back bone 101 running a software (SW) application 115 and coupled to a data repository 114. SW 115 may be a cloud wallet application for a dynamic transaction device like card 118 or another device used to interact with a sales or banking terminal (electronic machine/network node). Data repository 114 may include user identification and profile data, user accounts data, financial history data including transaction history, cloud wallet account data and the like.

Communications network 100 may include one or more financial institution domains 102 interfacing with a bank, credit union, or other financial account service site that may provide banking services to user 122 as a client. Domain 102 is a financial institution that may issue a financial transaction device to user 122 based on client status and account information. Financial institution 102 broadly represents entities that may be considered financial institutions with services used by user 122 like banks, credit unions, investment houses, etc. Financial institution 102 includes a server 110 supported by back bone 101. Server 110 hosts a software (SW) application 112 adapted to provide an electronic interface as a tool to user 122 for account use and management. SW 112 may include at least one component adapted to cooperate over a network with SW 115 running on server 113 in cloud wallet service domain 104.

Communications network 100 may include at least one network-based retailer selling products or services referenced herein by a server 107 supported by backbone 101, a software (SW) application 109 executing on server 107, and a data repository 108 coupled to server 107. Server 107 may represent any entity (network node) accessible to the user where a transaction may be performed. Data repository 108 may hold service and product related data, and user interaction and any transaction history user 122 has at the site.

Access to communications network backbone 101, which may represent the Internet in one embodiment, may be through an Internet service provider (ISP)/access Gateway 106 supported by backbone 101. A carrier network 103 is depicted that enables communications including wireless communications to be bridged onto communications network 100 through ISP Gateway 106. Carrier network may be a wireless 5G network or similar mobile network that user-operated mobile phone 122 may use to access the network and practice local and long-distance communications using the representative mobile telephone. Mobile telephone 122 may be Bluetooth™ enabled by hardware and software (SW) 121 labeled BT. Mobile phone 122 may host a software (SW) application 120 adapted as a thin mobile SW application including a network connection and browsing ability that may locally display information screens like screen 119 in display on mobile phone 122.

The user operating mobile phone 122 is at a business domain 116 that may be a service site, restaurant, retail establishment, parks service, or any venue that user 122 may enter to buy a product or service. In this embodiment, business 116 includes a point of sale (POS) machine or terminal 117 that takes, at least, credit and debit cards for satisfying financial transactions made by user 122. In this embodiment, user 122 has a dynamic universal transaction card 118 that may be electronically associated to a funding source account and may be accepted by terminal 117 to pay for goods or services. In a to preferred embodiment, user 122 may transmit account data to card 118 from the mobile telephone while running SW 120 and SW 121 wherein the card 118 is Bluetooth™ enabled to at least receive the account data (card number) wherein the account data represents an account that user 122 has represented in cloud wallet service 104.

User 122 may have several different accounts represented in cloud network 104 and dynamic transaction card 118 may be loaded with any of the user's account data to use that account to pay for goods or services during a transaction. SW 120 on mobile phone 122 enables the user to interact with cloud network 104 just before using card 118 at POS terminal 117 so that the user may determine which of several accounts might be imprinted or sent to card 118 for use as a device representing that account.

Cloud wallet application screen 119 on mobile phone 122 may be part of the interactive interface available to the user operating mobile phone 122 to load card 118 with a card number, security code, and other pertinent data so the card may be used as a card of the selected account. Any new account data that the user loads onto card 118 may overwrite any previous account data on the card memory.

In a preferred embodiment, SW 115 executing on server 113 in cloud wallet service 104 is adapted to at least receive and file electronic receipts on behalf of the active user operating mobile phone 122 in near real time. Card 118 may be used as the transaction device to pay for one or more transactions at POS terminal 117, the card written to by mobile phone 122 executing application 119 in broad respect while card 118 represents a particular account listed in cloud wallet service 104.

In one embodiment, the user may capture a hard receipt (not illustrated) associated with any transaction initiated and completed with card 118 that is printed out in form by POS terminal 117 immediately after a transaction is performed. In one embodiment, the hard receipt associated with a transaction performed with card 118 may be captured by a camera/scan application (not illustrated) resident on mobile phone 122. SW 120 may include an extension of SW 120 to an application on mobile phone 122 like a camera application. A receipt capture may be a semi-automated sequence of events that are triggered by a transaction event having occurred.

In this embodiment, dynamic card 118 may be used to conduct a transaction that will produce a receipt and may be enabled for wireless communication. In one embodiment, dynamic card 118 may send at least a data notification, a push notification command, or signal over the wireless link to mobile phone 122, for example, by Bluetooth™ wireless network (bi-directional line patterns). For example, dynamic card 118 may communicate via Bluetooth™ or other wireless protocol to mobile phone 122, the data notification, command, or signal, verifying that a transaction has been completed at POS terminal 117 and a receipt is forthcoming.

The communication may, in one embodiment, function as a direct command to execute a camera application resident on mobile phone 122 using SW 120 and interface 119. In another embodiment, the communication may be a simple notification with sound, flash or other haptic feedback that may prompt the user operating mobile phone 122 via a pop-up or other visual notification appearing in screen 119 that a transaction has occurred and a receipt is forthcoming and may be electronically captured.

In one embodiment, paper receipts are printed at the POS terminal 117 after a transaction is conducted and wherein the dynamic card 118 communicates a signal triggered by the read operation at the POS terminal, the signal processed by the cloud wallet application causing a camera application, via application extension, to execute automatically on mobile phone 122 to ready the camera or scanning device to capture/scan the printed receipt including the last four digits of the account number, the date, time, name of business, and items, service descriptions, and any other important information printed on the receipt paper.

In one embodiment, POS terminal 117 does not print a hard receipt but displays an electronic receipt on a display screen after the transaction that the user operating mobile phone 122 may see and use the phone to capture the display by image capture or scanner before the electronic receipt is requested by the user to be delivered to mobile phone 122 by email.

Optical character recognition (OCR) may also be employed, for example, during scan to render the electronic receipt editable if desired as an option to allow another application to manipulate data on the receipt. For example, enabling copy of some receipt data but not the whole image, or redacting or otherwise hiding or obscuring some of the receipt data, such as the merchant name, for example.

In another embodiment, the user operating mobile phone 122, wherein the mobile phone and the POS terminal are enabled for near field communication (NFC), may be using the mobile phone without an intermediate transaction device to transfer the correct wallet account information at the POS NFC interface to conduct a transaction. In both of these embodiments, the mobile phone 122 may capture a hard receipt or an electronic receipt displayed on a POS screen.

In still another embodiment wherein the POS terminal is not connected to a printer and has no display capability, a receipt may be captured electronically from the user's email account or messaging account if the merchant electronically mails or otherwise propagates the receipt to an end device controlled by the user. SW 120 may in addition to having a SW extension or application programming interface (API) to the user's camera application and permission granted by the user to grant the applications use the camera application or scanning application on the user's mobile phone 122, have extensions and or APIs to the user's email and text messaging applications where a receipt from a transaction conducted at a merchant POS terminal.

In the above scenario, the cloud wallet application may monitor the user's email or messaging account and may grab or capture the receipt from a merchant as an attachment to the email or text message. In a variation of this embodiment, the wallet application may be further enhanced with a SW extension that allows the application to use a screen scraping utility or snap-shot utility to capture a receipt in display (but not attached) in an open email window on the user's mobile phone where the wallet application may be further enhanced with a capability to open email messages.

A stated goal of the invention mentioned above and in addition to capturing receipts is to also aggregate receipts from transactions conducted by the user wherein the receipt aggregation is performed by cloud wallet account SW 120 executing on the user's mobile phone 122. The application may redirect those receipts (upload) to the cloud storage repository 114 at the wallet account domain 104 for later retrieval by the user or by an agent working on behalf of the user in tax planning, accounting, credit counseling, or other like services where user receipts must be accounted for.

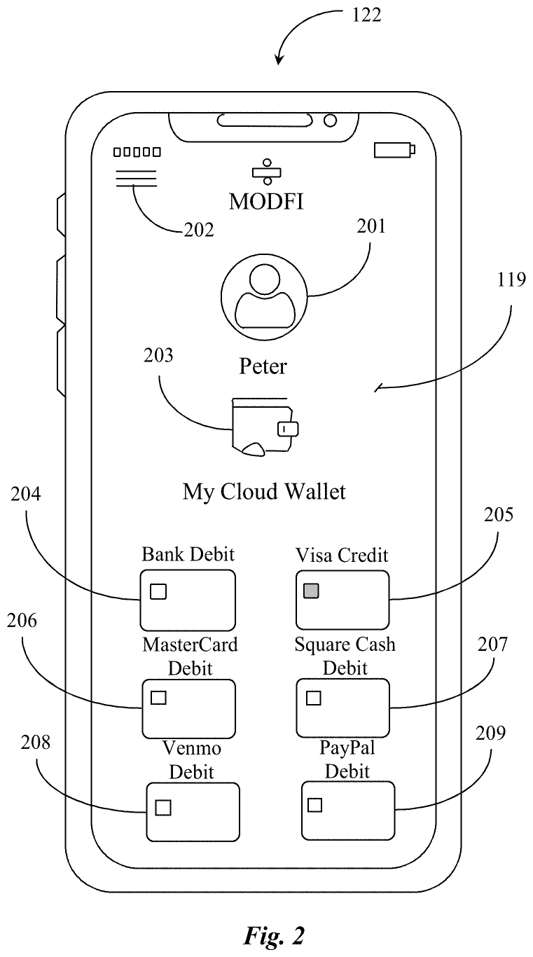

FIG. 2 is an elevation view of the mobile telephone of FIG. 1. executing the mobile payment application of FIG. 1. Mobile phone 122 has in display screen shot 119 depicting a cloud wallet account held by the user. In this embodiment, the account is a MODFI cloud wallet account known to the inventor and subscribed to by the user. However, any cloud wallet account or money payment application may be easily modified to practice transaction receipt capture and aggregation without departing from the spirit and scope of the invention.

Interface screen 119 includes a menu 202 of a variety of options that a user may invoke while using the application. The application is personalized to the user 201 and provides access to account data for all of the accounts that user 201 (Peter) has uploaded the information for in order to include the accounts as possible payment accounts that may be selected to fund initiated transactions. An icon 203 represents a folder or “wallet” listing all of the user accounts added to the service. Expanding wallet 203 may display several accounts separately for browsing, updating, or selection for a transaction. In this embodiment, accounts 204 through 209 are listed where 204 is a bank issued debit card account, 205 is a Visa issued credit card account, 206 is a MasterCard debit card account, 207 is a Square Cash debit card account, 208 is a Venmo debit card account, and 209 is a PayPal debit account.

User 201 may have in possession a dynamic transaction device like transaction card 118 of FIG. 1 and may using interface 119, select any one of accounts 204 through 209 to be assigned to the transaction device to use that account to fund any transaction as well as other tasks like using the dynamic card 118 loaded with any of the account data sets to access the account through an ATM terminal for example. In this embodiment, a user may select any one of accounts 204 through 209 and load that account data set onto the transaction device, for example, card 118 of FIG. 1, to perform a transaction with the card having the funds for the transaction deducted from the selected account.

The function of loading a dynamic card like card 118 of FIG. 1 with selected account data overwrites the existing account data on the card. A user may make more than one transaction with the transaction device loaded with a selected account and may overwrite the transaction device with any new account data (swapping accounts) making the next transaction associated with the next payment account data downloaded to the card. Using a transaction card with a writable memory is not required in order to practice the invention. A dedicated transaction device may be used provided the account on the card is represented in the client application and the electronic transaction record the card will be used to satisfy is accessible to the client application.

In one embodiment, receipt capture is a dynamic process occurring once at the relative moment in time of each transaction made. In one embodiment, the user may select the account desired for funding a next transaction and may capture a receipt upon evidence thereof at the POS terminal or interface.

In one embodiment, the user may click on any one of the listed accounts and mobile phone 122 may transmit an account data set from the selected account to the dynamic card (118), and may receive a signal, command, or notification from the wireless card just after transacting with the POS terminal. The signal, command, or notification results in automatic execution through the cloud wallet client application of the camera application or feature thereof such as the imaging and/or scanning feature. The signal, command, or notification may include an audio beep or other sound or vibration to gain the attention of the user operating phone 122 if the user is not already focused on receipt capture.

The user operating phone 122 may typically have a copy of a bill digitally available to mobile phone 122 either by transmission thereto or by optically scanning the bill that documents the transaction details before the card is inserted or otherwise used and before a receipt is issued by the merchant after the card data is either approved by checking the source account identified on the card. This information may be propagated from the user's mobile phone or device 122 over the communications network to the cloud network to be associated with the actual transaction event (card insert/swipe).

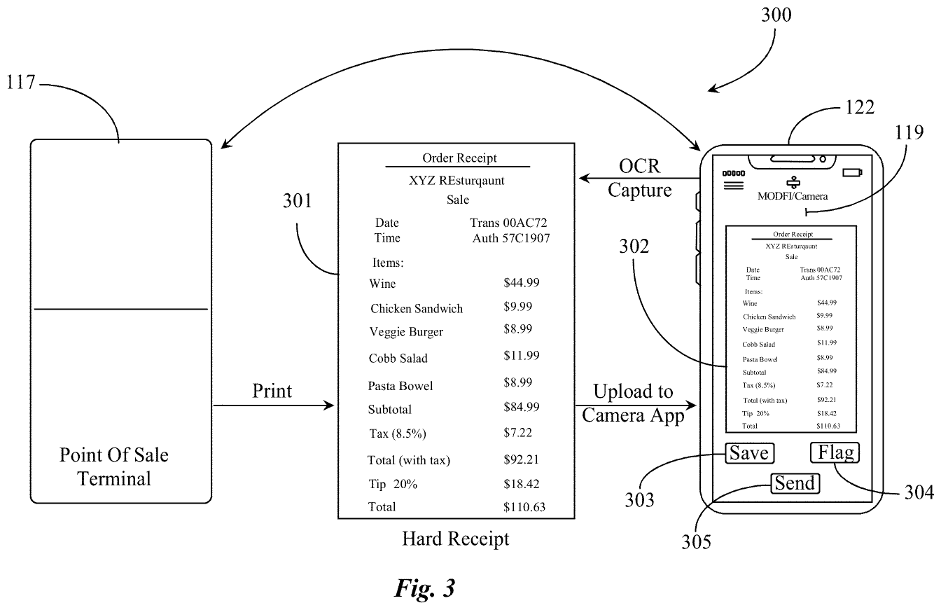

FIG. 3 is a block diagram depicting a receipt capture event of a receipt printed out by POS terminal 117 according to an embodiment of the present invention. POS terminal 117 is, in this embodiment, a POS terminal connected to a printing function and prints out a hard paper receipt referred to herein as receipt 301 after each transaction. Most In-person check-out counters offer this service. In this example, hard receipt 301 is a restaurant receipt including a date and time of the transaction, a transaction number, and an authorization number. The hard receipt lists the items purchased and the broken-down costs of each item, the percentage of sales tax, the tip amount, and the totals with tax and before tip and the grand total of the bill paid.

Receipt 301 may result from a dynamic card transaction like with dynamic card 118 or a mobile phone NFC transaction by mobile phone 122. In a case of transacting with a dynamic card like card 118 described above or perhaps another Bluetooth™ enabled transaction device that may be adapted to work with the cloud wallet application on phone 122, a signal, command, or notification may be communicated from the transaction device to the mobile phone as the card is being read. The signal, command, or notification may be received at phone 122 by application screen 119. Upon receipt of the communication, the application may execute the camera and scanning application feature used to capture hard receipt 301. In this way the user does not have to remember to capture the receipt once it is printed. The signal may be a text of the receipt at phone 122.

The automated execution of the capture features of the user's camera application may include a vibration or notification sound so the user will feel or hear it and take the task of positioning the capture hardware to capture or scan the receipt. Once the hard receipt 301 is captured and is on mobile phone 122, the image of the receipt may be displayed as receipt image 302 on application screen 119. In this embodiment, the user may select to save the receipt by selecting a save function 303. This function may save the receipt to a specific folder on mobile phone 122. In one embodiment, the user may also categorize captured receipt 302 as a wholly or partly tax-deductible receipt by selecting a flagging option 304. The user may also select a send option 305 that, if selected communicates the electronic receipt copy 302 to the cloud wallet service for processing and storage.

It is noted herein the image capture feature used in the camera application captures the receipt and uploads it to the cloud wallet screen 119 on mobile phone 122 as electronic image or OCR'd document 302. In one embodiment, receipt 302 is a static image and cannot be manipulated by software and is stored as an image file at the cloud wallet service. In another embodiment, captured and displayed receipt 302 is an electronic document manipulate-able by SW 120 on mobile phone 122. A user may be enabled to redact a portion of the receipt or even recalculate what the user has actually paid considering the possibility of a receipt that might be the result of a shared transaction where the user was reimbursed for another user or user's shares of the bill.

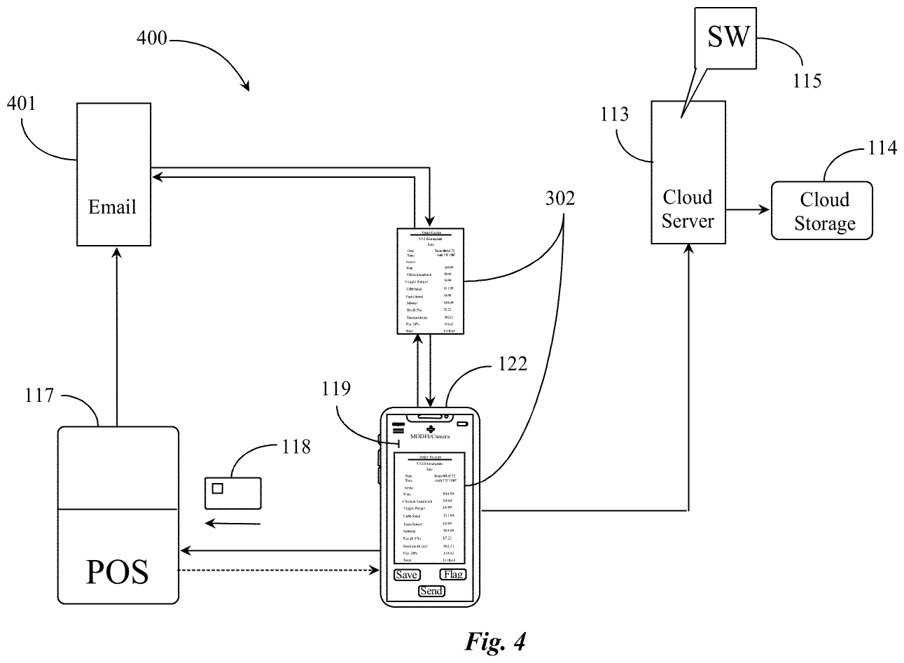

FIG. 4 is an architectural diagram of an Email loop 400 supporting electronic receipt capture according to another embodiment. In this example, POS terminal 117 does not print out hard receipts that the user might capture using mobile phone 122. Therefore, it is assumed in this embodiment that the merchant has the email address or phone number of the user. In one embodiment, the user may give the person the correct email address at the time of the transaction if the merchant does not already have the address in the system.

In this embodiment, the user operating mobile phone 122 has application screen 119 running when he or she initiates a transaction at POS terminal 117 using dynamic card 118. At the time of transaction when the card is read and approved for the transaction amount, POS terminal sends an electronic receipt to the user's email or text account referenced herein as email server 401. Card 118 may include Bluetooth™ enablement and a micro controller unit (MCU) on board and sends a signal, command, or notification via Bluetooth™ to mobile phone 122 that is received by application screen 119. Application 120 may include an extension to automatically open the user's email or text account to retrieve email. The email feature of the user's email account may log into email server 401 and retrieve the email from the merchant that includes the attached or embedded email receipt 302. In this embodiment, the email attachment or embedded receipt 302 displays in application screen 119. The application may upload receipt 302 to cloud server 113 aided by SW 115 and the cloud wallet service may archive the receipt for the user in cloud data storage 114.

It may be noted that a number of tasks may be performed relative to receipt 302 by the user operating SW 120 on mobile phone 122. The receipt might be flagged as a tax deduction, flagged for reimbursement, checked for correct math and corrected as for total amount (if incorrect), marked as a shared transaction where the user may append the receipt to include the user's actual amount paid.(shared transaction), or redacted in portion by the user. In a preferred embodiment, receipt 302 is processed in a semi-automated manner so that the user may not forget about the receipt and have to find it again at tax time.

The semi-automation during transaction and upload to the cloud wallet service ensures that the receipt is aggregated and not left out or forgotten by the user. The signal command or notification made from card 118 ensures the user will at least be aware that the receipt is available and may be immediately aggregated and stored. The cloud wallet service (104, FIG. 1) may archive receipts like receipt 302 according to the accounts sourced to pay for the transactions.

In one embodiment, receipts that are archived in separate account activity histories may be retrieved according to receipt category. For example a user operating mobile phone through application screen 119 might retrieve all receipts that were fuel related and toll receipts that may be travel expenses though the receipts are archived by the cloud wallet accounts that funded the transactions producing those receipts. Receipts that are printed and captured or captured electronically are aggregated and are retrievable by the user or agent working on behalf of the user like a tax preparer or a certified public accountant (CPA). In one embodiment, a user may simply capture a receipt that is hand written, or one that resulted from a transaction where cash was used to pay a bill and may upload that receipt to the cloud wallet service if the user has reason to like the transaction being tax deductible.

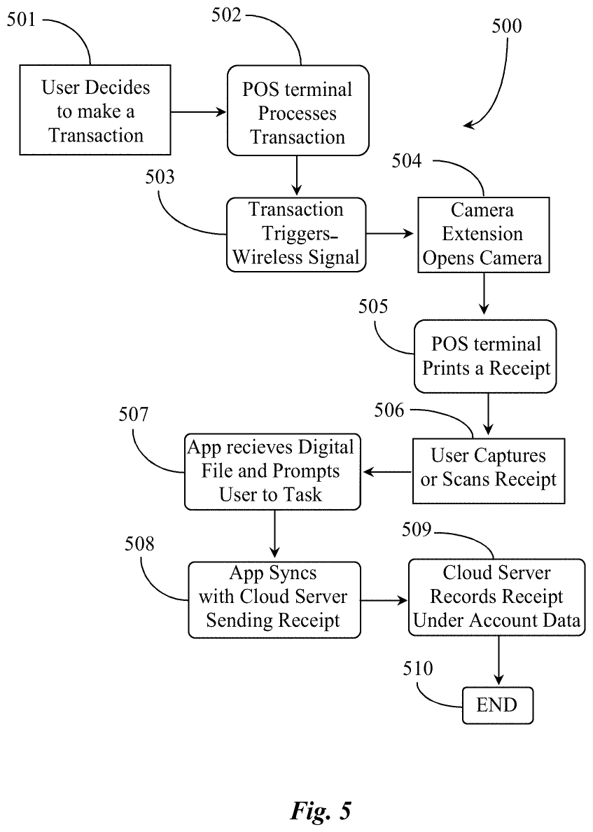

FIG. 5 is a process flow chart 500 depicting steps for capturing and storing a receipt electronically according to one embodiment of the invention. At step 501, a user operating mobile phone 122 as a transaction device or as a parent to a transaction device like dynamic card 118 of FIG. 1 initiates a transaction at a POS terminal. At step 502, the POS terminal processes the transaction. At step 503, the transaction event (card read/approval) is detected by the transaction device, in this case, a dynamic card analogous to card 118 of FIG. 1. Card 118 sends a wireless signal, command, or notification in step 503 that may cause the user's camera or scanning application features to open in step 504 in association to SW 120 and screen 119.

At step 505, the POS terminal 117 may print a hard paper receipt. The user, having received signal notification or direct command, captures, or scans the receipt at step 506. In this step the signal, notification or command executes the camera or scan feature through the screen. The signal, notification, or command may include audio alert or vibration sequence, so the user does not miss the opportunity to use the executed feature to capture the receipt by imaging or scanning, the receipt uploaded to the user's mobile device.

At step 507, the application, a thin client analogous to (SW 120) of cloud wallet software (SW) 115 of FIG. 1, receives the digital receipt and prompts the user to task relative to the receipt. Various options might be provided for the user to flag the receipt for tax deduction, mark the receipt as an expense for business or job reimbursement, redact the merchant name on the receipt, categorize the receipt, quantify an exact amount the user has contributed to the receipt total (shared receipt), mark specific line items as deductible for tax purposes, etc.

At step 508, the application may synchronize with a cloud wallet server analogous to server 113 of FIG. 1 aided by SW 115 and may send the now electronic receipt to the cloud wallet service for archiving on behalf of the user. At step 509, the wallet service may record the receipt under the account data for that receipt or in the activity log for the wallet account that funded the transaction. The process may end at step 510. It is noted herein that the user may through the client application, connect to the wallet service and review receipts, retrieve receipts, search for specific receipts by category, or by date, and so on.

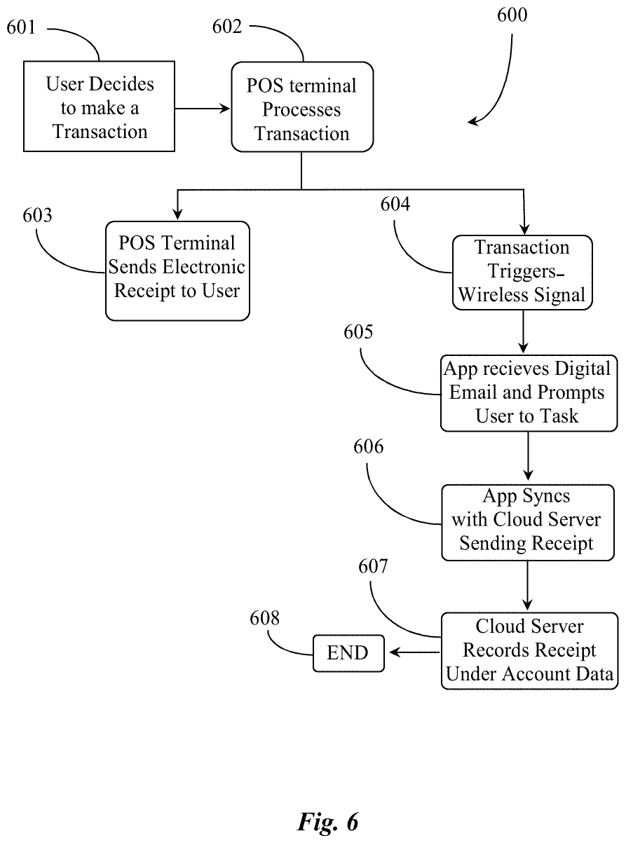

FIG. 6 is a process flow chart 600 depicting steps for capturing and storing a receipt electronically according to another embodiment of the invention. At step 601, a user operating mobile phone 122 as a transaction device or as a parent to a transaction device like dynamic card 118 of FIG. 1 initiates a transaction at a POS terminal. At step 602, the POS terminal processes the transaction. The transaction event (card read/approval) is detected by the transaction device, in this case, a dynamic card analogous to card 118 of FIG. 1. At step 603, the POS terminal analogous to terminal 117 of FIG. 1 sends an electronic receipt to the user, typically via text or email account known to the merchant and wherein the email was provided by the user at some point in the past or is provided during the transaction.

At step 604, card 118 sends a wireless signal, command, or notification that may cause the user's email request feature to execute and open in association to SW 120 and screen 119. In this step the signal, notification or command executes the email request feature through the screen. The signal, notification, or command may include a text, audio alert or vibration sequence, so the user does not miss the opportunity to use the executed feature to capture the receipt by downloading the receipt to the user's mobile device.

At step 605, the application, a thin client analogous to (SW 120) of cloud wallet software (SW) 115 of FIG. 1, receives the digital receipt and prompts the user to task relative to the receipt. Various options might be provided for the user to flag the receipt for tax deduction, mark the receipt as an expense for business or job reimbursement, redact the merchant name on the receipt, categorize the receipt, quantify an exact amount the user has contributed to the receipt total (shared receipt), mark specific line items as deductible for tax purposes, etc.

At step 606, the application may synchronize with a cloud wallet server analogous to server 113 of FIG. 1 aided by SW 115 and may send the now electronic receipt to the cloud wallet service for archiving on behalf of the user. At step 607, the wallet service may record the receipt under the account data for that receipt or in the activity log for the wallet account that funded the transaction. The process may end at step 607. It is noted herein that a user may skip or override receipt capture as detailed in processes of FIG. 5 and of FIG. 6 if that user does not wish to save a receipt for a transaction. In one aspect of both processes, a user may configure transaction accounts in the cloud wallet service to require receipt capture whenever that particular account or accounts are used.

In one possible embodiment, a dynamic card enabled for Bluetooth™ and having a writable memory may receive an electronic image from the POS if the POS is enabled to write such as image to the card. The dynamic card may, in that case, send the electronic receipt back to the mobile phone over the wireless connection. In still a further embodiment, the dynamic card may have a screen scrape application provided in available memory allocated for the purpose and may copy an image of the receipt displayed in a display screen on the POS terminal, however, a POS terminal would have to be modified with an electronic access or read path from the card slot interface directly to the display screen.

The just described embodiment may not be preferred for security reasons that the card may capture a different receipt image but electronically it is possible for a device having an MCU and a thin firmware executable on the card to capture the contents of the POS screen. In that case, the card may immediately communicate the captured image to the mobile phone or may transfer the image, for example, when docked with the phone as is known to the inventor for one type of dynamic transaction card.

### Voice Enabled Tagging and Voice Enabled Receipt Characterization

In one embodiment of the invention, a user may voice-tag a captured receipt using voice to text capability on the user's mobile telephone analogous to phone 122 of FIG. 1 to aided by SW 120.

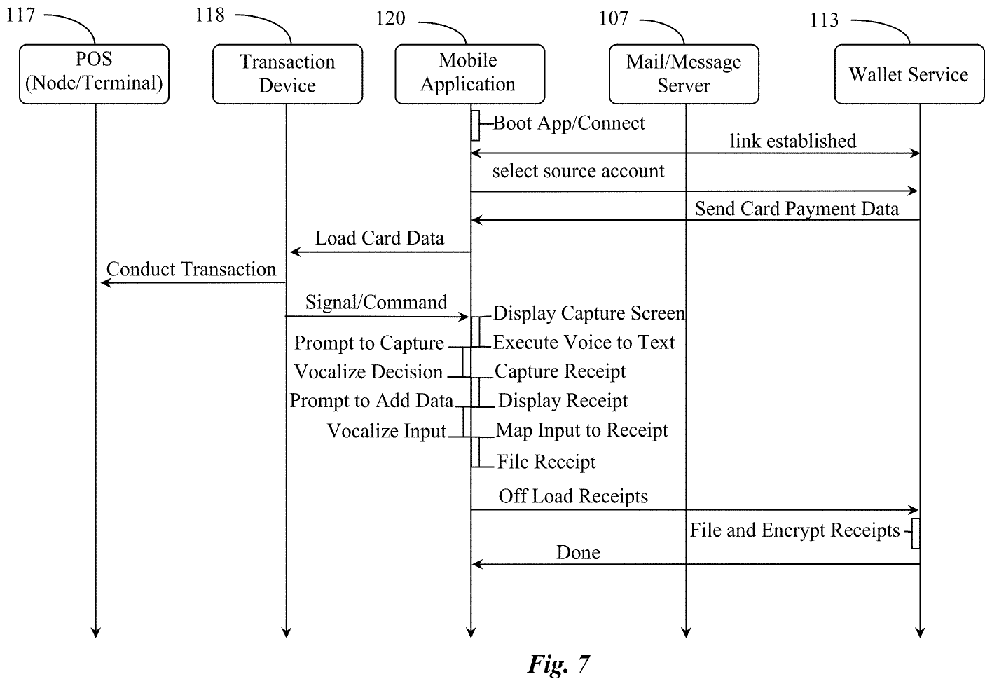

FIG. 7 is a sequence diagram depicting a semi-automated interaction sequence supporting voice characterization tagging of a captured receipt according to an embodiment of the present invention. A user operating a mobile telephone and using a transaction device or the phone itself as a transaction device can interact with any point of sale (POS) terminal or node to enable receipt capture as described further above. Before engaging with a POS terminal to transact through the terminal, the user executes or boots a wallet application 120 resident on the mobile telephone or other mobile device having connection to a cloud wallet service or other network-based money payment SW service.

A working network connection is then established over the network with a network server 113, referred to herein as wallet server 113. As described further above, this enables the user to select a source account to cover for a transaction, for example, when using a dynamic writable transaction card or other writable transaction device.

Wallet server 113 sends the requested card data in encrypted format to the user, typically to the user's mobile device running the wallet application 120. The user may receive the card data in the wallet application and may send that card data to a transaction device like device 118 (dynamic card) via a wireless communications protocol like Bluetooth™. The card data communicated to the card overwrites and other card data that was previously on the card. Thus, the user loads the card data received from server 113 onto dynamic smart card 118 prior to initiating a transaction at terminal 117.

The user may then use card 118 to conduct the transaction wherein POS terminal 117 reads the loaded card data from a magnetic stripe or reader interface when the card is inserted. At the time reading occurs, a signal push notification or command is sent back to the user's mobile phone to cause the wallet application to execute one or more features in other resident applications that may be useful in receipt capture. In one embodiment, the wallet executes a voice input feature like a microphone application feature which enables the user to speak into a microphone on the mobile telephone. The mic feature enabling voice to text (VTT) may be executed automatically via a SW extension provided in SW 120 from inside the application on user's microphone.

If wallet application 120 is not running on the phone then the signal, command, or push notification may be received by a watch extension and used to open SW 120, which in turn may immediately execute other appropriate features resident in other applications on the phone. More particularly, the signal command or notification may result in a display of a receipt capture screen analogous to screen 119 of FIG. 1, while executing a voice to text feature or an audio recording resident on the mobile phone.

A first prompt to the user may appear on screen asking if the user wishes to capture the forthcoming receipt for the instant transaction. The prompt may be a simple phrase Capture Receipt followed by a yes and or a no touch screen option. If the user wishes, the user may say yes or no into the microphone to continue with the process. If the user declines, the sequence ends because the user is not interested in that particular receipt. In the event the user wishes to capture the receipt, the user may vocalize that decision by saying yes or touching the yes option on screen.

The application 120 may as a result of a yes answer, execute the receipt capture feature via SW extension and user permission. The user may then capture the receipt using one or another executed feature. In one aspect of this sequence more than one capture feature might be offered like a camera imaging feature, a message retrieval feature, or a scan feature using optical character recognition (OCR). Once the receipt has been captured, it is immediately displayed or pushed onto the application screen 119 so the user may visualize the receipt and in some cases manipulate the receipt according to options provided like redaction, enlarge, crop, etc. that may be provided in a pane on the capture screen showing the receipt.

Once a user is satisfied with the receipt in display, the user may save the receipt in its current form and a prompt may appear asking the user if the user wants to add any characterization data to the receipt. The receipt has information that helps categorize it and that information may be used in archiving etc. However, the user may want to describe a business situation including names of parties to a transaction etc. depending upon the type of transaction.

Rather than manually typing data into a screen dialog box from a small key pad typical of a mobile phone, the user may use the voice to text feature or make a voice recording to input characterizations about the receipt including any details the user cares to vocalize. In one embodiment, the user makes a recording and that recording is saved as an audio recording and transcribed later and associated with the receipt. In another embodiment, the user vocalizes characterizations that appear as typed text in a voice to text scenario wherein the text is associated or tagged to the receipt.

Either type of input such as audio recording or voice to text input is mapped or linked to the receipt on the user's mobile device. After the user has finished characterizing the receipt the user may hit save or done on the screen and the application may file the receipt for later upload or offload onto another device or to the cloud wallet service 104 introduced in FIG. 1 above. Any time after the transaction, the user may upload the receipt and the associated data and or media to server 113 at the cloud wallet service 104. Once in house in cloud wallet the SW 115 running on the server may transcribe audio attached to the receipt and create a text record as well as save the audio if the user prefers. The receipt and audio text characterization files may be stored together according to user metrics or a user-created file system or automatically accordingly to user set parameters.

In one embodiment, the wallet service files the receipts and associated data or media under the activity histories of the accounts that were used to cover the transactions. In some embodiments a user may create a single archive containing all of the receipts data and media associated therewith. In this embodiment, the receipts may be searched according to any of the metrics on the receipts including account source and any data text or audio metrics provided by the user in receipt categorization. The features residing on the user's mobile phone may be resident features of other applications that are tied to application 120 through extensions or APIs such that they may be borrowed and integrated as application features of application 120.

The exact method used to capture the receipt initially may be any of the features previously described above. A user may also say no to receipt characterization using voice and instead operate with standard receipt categorizations offered as interactive options in the application screen 119 such as gas receipt, business trip hotel receipt, car rental receipt business trip, etc. Once the user has the electronic version of a receipt captured, the user may practice the categorization and characterization methods while connected to server 113 or while offline.

It will be apparent with skill in the art that the voice enabled characterization process of captured receipts of the present invention may be provided using some or all the elements described herein. The arrangement of elements and functionality thereof relative to the receipt characterization process of the invention is described in different embodiments each of which is an implementation of the present invention. While the uses and methods are described in enabling detail herein, it is to be noted that many alterations could be made in the details of the construction and the arrangement of the elements without departing from the spirit and scope of this invention. The present invention is limited only by the breadth of the claims below.

1. A method for characterization of an electronic receipt acquired through a receipt capture process to a host computing device is provided, the capture process using image capture, scan capture, or electronic capture features leveraged through SW extension of a mobile or digital wallet, the wallet or money pay application running on the host computing device, the receipt accounting for a transaction from a point of sale (POS) terminal or network node including the steps:
(a) capturing the receipt for display in a mobile wallet, digital wallet application or money pay application, the mobile wallet, digital wallet application or money pay application screen on the host computing device using one of one or more application features available on the computing device;
(b) resulting from a prompt in the application screen, determining to characterize the receipt captured using one of an audio recording feature or a voice-to text-feature resident on the host computing device;
(c) inputting voice through a microphone on the computing device to create an audio recording or a voice-to-text input to the application containing the characterization of the captured receipt; and
(d) saving the characterization text or media and receipt in association to file on the host computing device using a save function selectable by a user while viewing the application screen displaying the captured receipt.

2. The method of claim 1, wherein in (a) the receipt is for a transaction conducted with a transaction device wherein the transaction device is a dynamic transaction card having a writable memory, a micro controller unit (MCU), and a wireless chip for wireless communications.

3. The method of claim 1, wherein in (b) the application is a digital, mobile wallet application or a payment application running on the host computing device functioning as a transaction device.

4. The method of claim 2, wherein in (b) the application is a mobile or digital wallet application or a payment application running on the host computing device to the transaction device and wherein the host computing device is a mobile phone.

5. The method of claim 1, wherein in (c) the one or more application features executed are executed by a user operating a digital wallet, mobile wallet application or a payment application running on the host computing device functioning as a transaction device.
